(19) United States
(12) Patent Application Publication
(10) Pub. No.: US 2004/0068539 A1
(43) Pub. Date: Apr. 8, 2004

(54) Method and system for sharing general packet radio service cards over local area network

(76) Inventors: Cheng-Shing Lai, Taipei (TW); Yongqian Gu, Nanjing (CN); Hong Ding, Nanjing (CN)

Correspondence Address: BIRCH STEWART KOLASCH & BIRCH, PO BOX 747, FALLS CHURCH, VA, 22040-0747, US

(21) Appl. No.: 10/261,953

(22) Filed: Oct. 2, 2002

(51) Int. Cl. G06F 15/16

(52) U.S. Cl. 709/203

(57) ABSTRACT

A method for sharing a single general packet radio service (GPRS) card over a LAN. First, registration information is transmitted from one or more clients to a server which comprises a GPRS card, and the server checks whether each of the clients has usage authorization. Next, the server stores the registration information transmitted from authorized clients and transmits successful registration information thereto. Finally, accepted clients can perform wireless communication by the GPRS card.

### BACKGROUND OF THE INVENTION

1. Field of the Invention

The present invention relates to a technology for client/server architecture and particularly to a method and a system for sharing a single general packet radio service (GPRS) card over a Local Area Network (LAN).

2. Description of the Related Art

A general packet radio service (GPRS) card is used in wireless communication, coupled to a computer by a universal serial bus (USB). Using the GPRS card, the computer is connected to a network and users can make wireless telephone calls. One GPRS card is only used in one computer. Different computers in the same LAN must use several GPRS cards. Thus, the cost of establishing one LAN is high.

### SUMMARY OF THE INVENTION

Accordingly, an object of the present invention is to provide a method and a system for sharing a single general packet radio service (GPRS) card over a LAN to share information in the LAN, thereby decreasing the cost of establishing one LAN.

The present invention provides a method for sharing a single general packet radio service (GPRS) card over a LAN. First, registration information is transmitted from one or more clients to a server which comprises a GPRS card, and the server checks whether each of the clients has usage authorization. Next, the server stores the registration information transmitted from authorized clients and transmits successful registration information thereto. Finally, accepted clients can perform wireless communication by the GPRS card.

Subsequently, accepted clients can initiate wireless communication as needed

Furthermore, the invention also provides a system for sharing a single general packet radio service (GPRS) card over a LAN. The system comprises one or more clients and a server. The server is coupled to the clients through the LAN. Registration information transmitted from the clients is received by the server. The server checks whether each of the clients has usage authorization, and transmits successful registration information thereto. The server comprises a GPRS card for accepted clients to communicate wirelessly. The GPRS card receives data information for a given accepted client from a GPRS network and transmits the data information from the server to the client. In addition, the GPRS card also receives data information from accepted clients and transmits the data information from the server to the GPRS network.

### BRIEF DESCRIPTION OF THE DRAWINGS

The present invention can be more fully understood by reading the subsequent detailed description in conjunction with the examples and references made to the accompanying drawings, wherein:

FIG. 1 is a flowchart illustrating the method for sharing a single general packet radio service (GPRS) card over a LAN according to the embodiment of the present invention;

FIG. 2a and FIG. 2b are flowcharts illustrating an example of the step S106 according to the embodiment shown in FIG. 1;

FIG. 3a and FIG. 3b are flowcharts illustrating another example of the step S106 according to the embodiment shown in FIG. 1;

FIG. 4 is a diagram illustrating the configuration of the system for sharing a single general packet radio service (GPRS) card over a LAN according to the embodiment of the present invention; and

FIG. 5 is a block diagram illustrating an example of the GPRS card in the embodiment of the present invention.

### DETAILED DESCRIPTION OF THE INVENTION

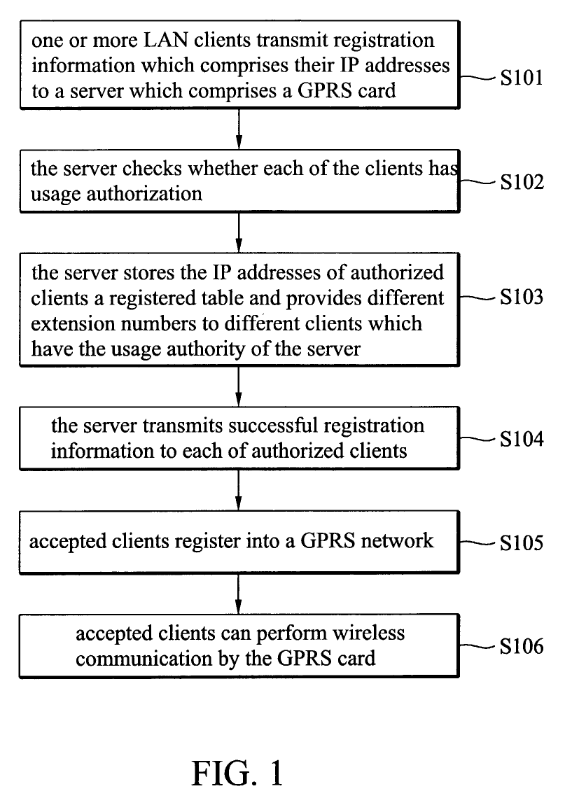

FIG. 1 is a flowchart illustrating the method for sharing a single general packet radio service (GPRS) card over a LAN according to the embodiment of the present invention.

First, one or more LAN clients transmit registration information which comprises their IP addresses to a server which comprises a GPRS card (S101), and the server checks whether each of the clients has usage authorization (S102). Next, the server stores the IP addresses of authorized clients a registered table and provides different extension numbers to different clients which have the usage authority of the server (S103), and the server transmits successful registration information to each of authorized clients (S104). Accepted clients register into a GPRS network (S105). Finally, accepted clients can perform wireless communication by the GPRS card (S106). In addition, each of accepted clients can determine whether the client requires the wireless communication. If the client determines not to perform the wireless communication, pause information is sent to the server. If a user makes a call to communicate with the client, the server detects the client is engaged and informs the user that the telephone call can not be connected. The pause information may be new registration information which comprises an IP address of (0.0.0.0).

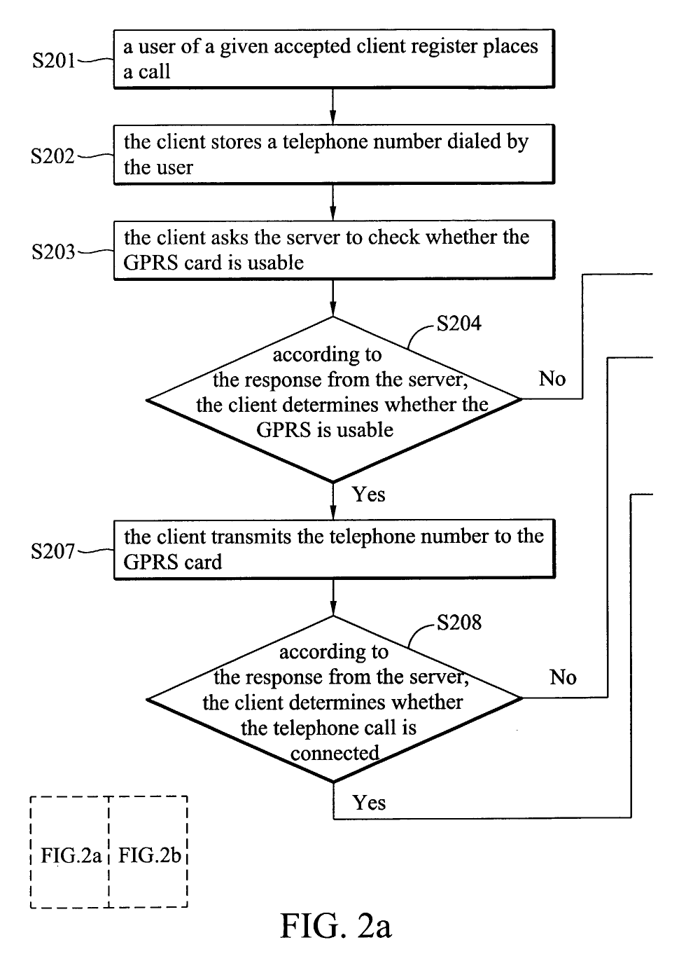

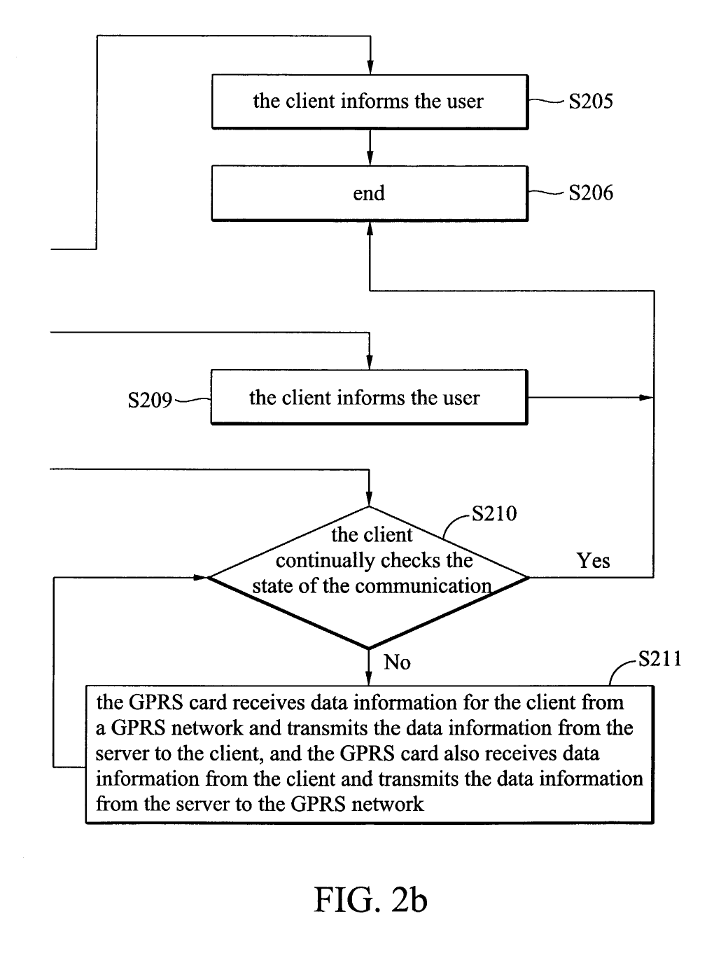

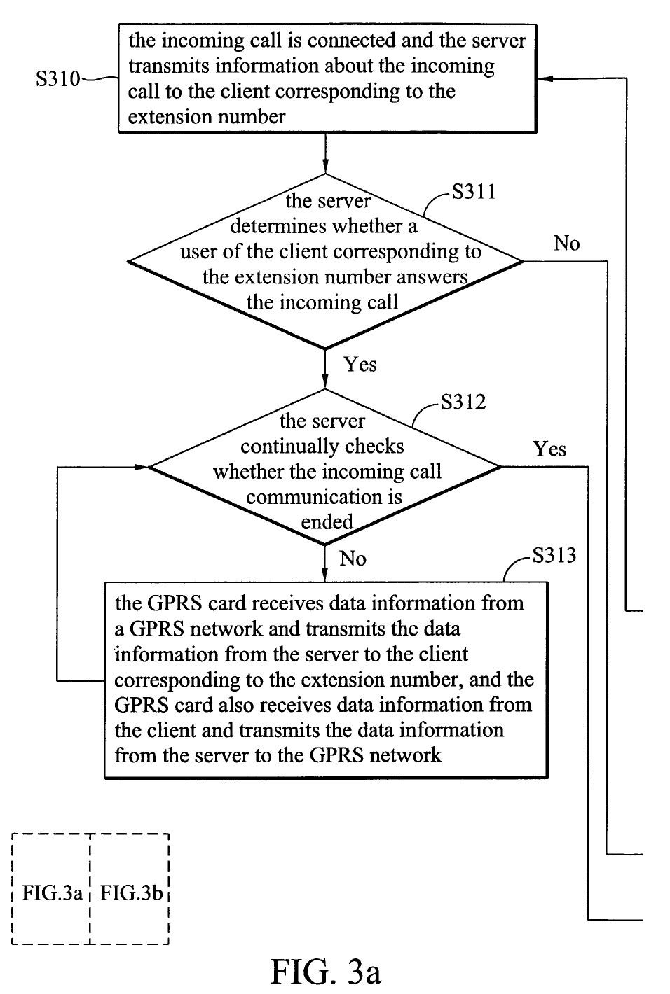

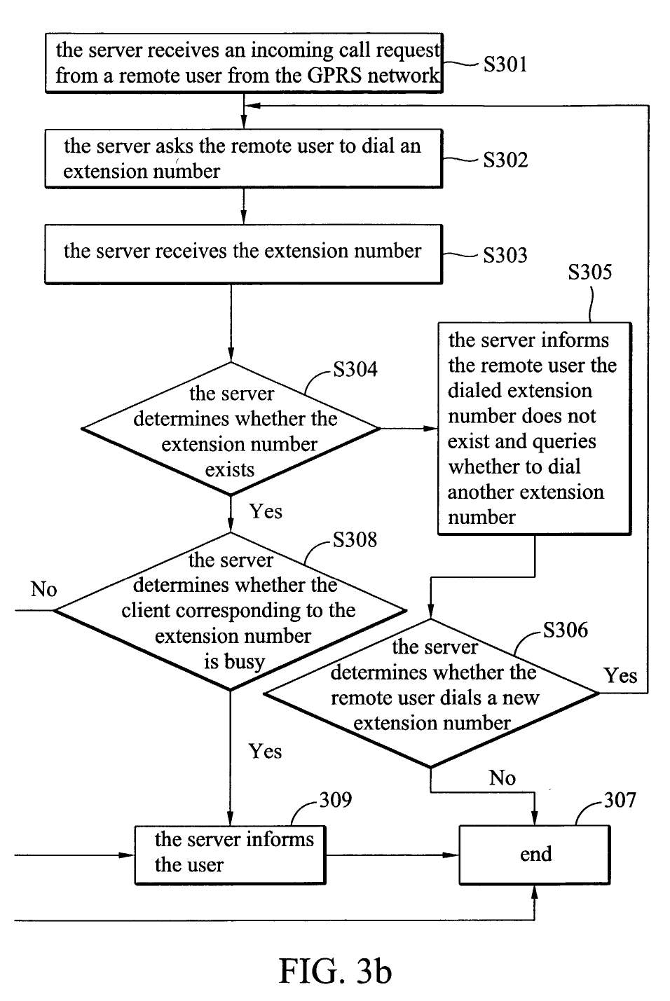

Through the following description, a detailed example of wireless communication by the GPRS card is provided in conjunction with FIGS 2a˜2b and FIGS. 3a˜3b.

FIG. 2a and FIG. 2b are flowcharts illustrating an example of the step S106 according to the embodiment shown in FIG. 1. First, a user of a given accepted client register places a call (S201). The client stores a telephone number dialed by the user (S202). The client asks the server to check whether the GPRS card is usable (S203). According to the response from the server, the client determines whether the GPRS is usable (S204). If the GPRS card is not usable, the client informs the user (S205), and the procedure is ended (S206). If the GPRS card is usable, the client transmits the telephone number to the GPRS card (S207). According to the response from the server, the client determines whether the telephone call is connected (S208). If the telephone call is not connected, the client informs the user (S209), and the procedure is ended (S206). If the telephone call is connected, the client continually checks the state of the communication (S210). Before the telephone communication is ended, the GPRS card receives data information for the client from a GPRS network and transmits the data information from the server to the client, and the GPRS card also receives data information from the client and transmits the data information from the server to the GPRS network (S211). If the telephone communication is ended, the procedure is ended (S206).

FIG. 3a and FIG. 3b are flowcharts illustrating another example of the step S106 according to the embodiment shown in FIG. 1. First, the server receives an incoming call request from a remote user from the GPRS network (S301). The server asks the remote user to dial an extension number (S302). After the server receives the extension number (S303), the server determines whether the extension number exists (S304). If the extension number does not exist, the server informs the remote user the dialed extension number does not exist and queries whether to dial another extension number (S305). The server determines whether the remote user dials a new extension number (S306). If the remote user dials the new extension number, the server repeats the step S302. If the remote user does not dial a new extension number, the procedure is ended (S307).

If the extension number exists, the server determines whether the client corresponding to the extension number is busy (S308). If the client corresponding to the extension number is busy, the server informs the user (S309), and the procedure is ended (S307). If the client corresponding to the extension number is not busy, the incoming call is connected and the server transmits information about the incoming call to the client corresponding to the extension number (S310), and the server determines whether a user of the client corresponding to the extension number answers the incoming call (S311). If the user of the client corresponding to the extension number does not answer the incoming call, the server informs the remote user the incoming call is not connected (S309). If the user of the client corresponding to the extension number answers the incoming call, the server continually checks whether the incoming call communication is ended (S312). Before the incoming call communication is ended, the GPRS card receives data information from a GPRS network and transmits the data information from the server to the client corresponding to the extension number, and the GPRS card also receives data information from the client and transmits the data information from the server to the GPRS network (S313). If the incoming call is ended, the procedure is ended (S307).

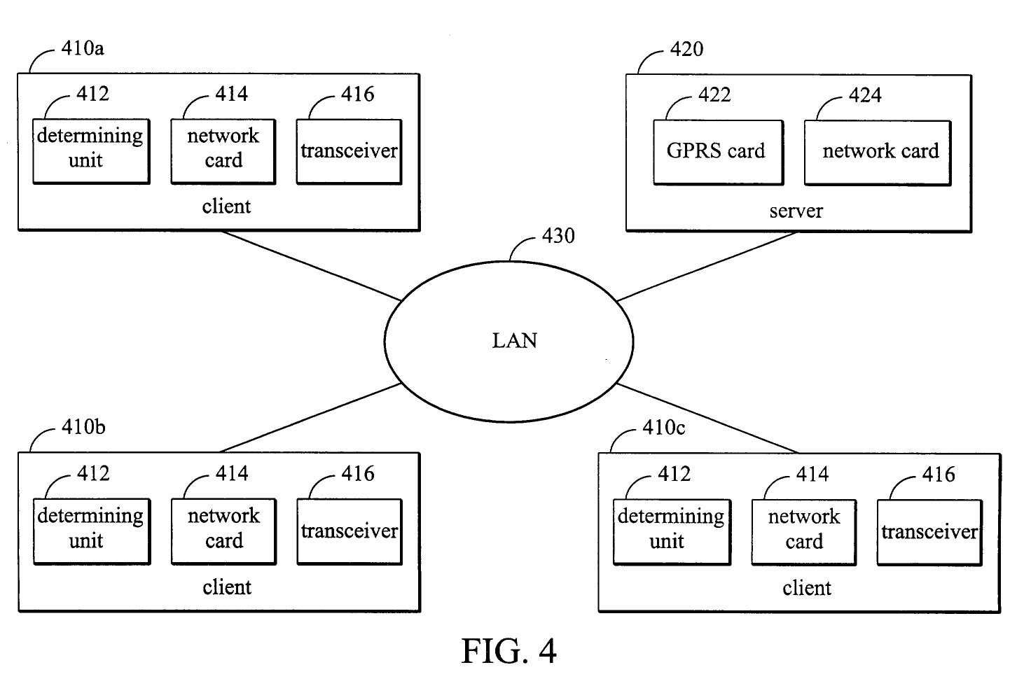

FIG. 4 is a diagram illustrating the configuration of the system for sharing a single general packet radio service (GPRS) card over a LAN according to the embodiment of the present invention. As shown in FIG. 4, the system for sharing a single general packet radio service (GPRS) card over a LAN comprises a server 420 and a plurality of clients. In the embodiments, three clients 41a˜410c are used as an example. The server 420 is connected to the clients 410a˜410c through a LAN 430 such as Ethernet. The clients 410a˜410c do not comprise a GPRS card.

The server 420 comprises a GPRS card 422 and a network card 424. The server 420 is connected to the LAN 430 by the network card 424. The registration information transmitted from the clients 410a˜410c is received by the server 420. The server checks 420 whether each of the clients 410a˜410c has usage authorization 420, and transmits successful registration information thereto. Accepted clients can perform wireless communication by the GPRS card 422.

Each of the clients 410a˜410c comprises a determining unit 412, a network card 414 and a transceiver 416. The determining unit 412 determines whether the clients 410a˜410c require wireless communication. When one of the clients 410a˜410c determines not to perform the wireless communication, the client transmits pause information to the server 420. If a user makes a telephone call to communicate with the client, the server 420 detects the client is engaged and informs the user that the telephone call can not be connected. The pause information may be new registration information which comprises an IP address of (0.0.0.0). Each of the clients 410a˜410c is connected to the LAN 430 by the network card 414. The transceiver 416 receives data information from the server 420 and transmits data information from the client to the server 420.

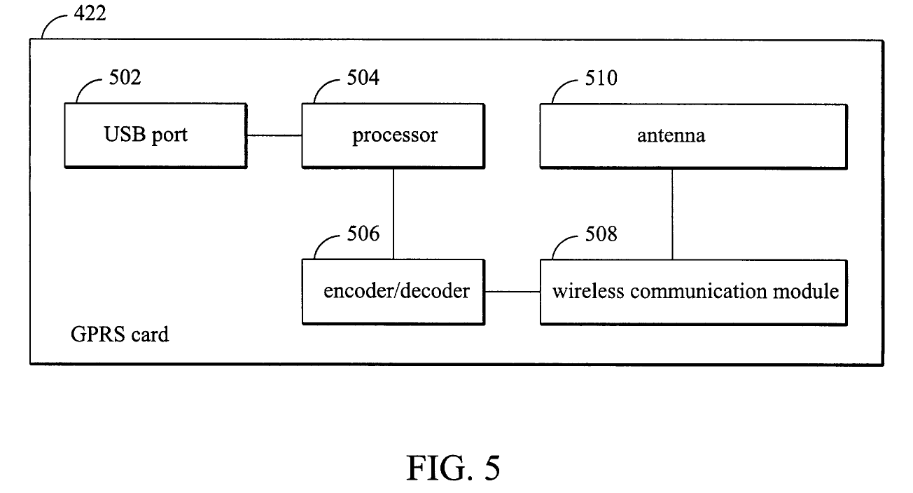

FIG. 5 is a block diagram illustrating an example of the GPRS card in the embodiment of the present invention. The GPRS card shown in FIG. 5 is an example of the GPRS card 422 in the server 420 shown in FIG. 4. The GPRS card 422 comprises a USB port 502, a processor 504, an encoder/decoder (CODEC) 506, a wireless communication module 508 and an antenna 510. The USB port 502 is connected to the server 420. The processor 504 is connected to the USB port 502. The encoder/decoder (CODEC) 506 is connected to the processor 504. The wireless communication module 508 is connected to the CODEC 506. The antenna 510 is connected to the wireless communication module 508. The antenna 510 receives data information from the GPRS network (not shown) and transmits data information received from the clients to the GPRS network.

The antenna 510 receives data information from the GPRS network (not shown) and transmits it to the CODEC 506 through the wireless communication module 508. The CODEC 506 decodes the data information and transmits the decoded data information to the processor 504. The processor 504 determines which client will receive the decoded data information and transmits the decoded data information into the server 420 through the USB port 502, and the server 420 transmits it to the corresponding client.

The server 420 receives data information from the clients and transmits it into the GPRS card 422 through the USB port 502. After processing in the processor 504, the data information is transmitted to the CODEC 506. The CODEC 506 encodes the data information and transmits the encoded data information to the wireless communication module 508. The wireless communication module 508 transmits the encoded data information, and the antenna 510 transmits the encoded data information to the GPRS network.

As described above, the method and the system provided by the present invention share one general packet radio service (GPRS) card over a LAN. Thus, the system of the present invention shares information in the LAN and decreases network costs.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for sharing a single general packet radio service (GPRS) card over a LAN, comprising the steps of:
transmitting registration information from one or more clients to a server which comprises a GPRS card;
checking whether each of the clients has usage authorization;
storing the registration information transmitted from authorized clients and transmitting successful registration information thereto; and
using the GPRS card to allow accepted clients to perform wireless communication.

2. The method as claimed in claim 1, wherein use of the GPRS card further comprises:
registering accepted clients in a GPRS network;
transmitting data information from accepted clients to the server; and
transmitting the data information from the server to the server GPRS network through the GPRS card.

3. The method as claimed in claim 1, wherein use of the GPRS card further comprises:
registering accepted clients in a GPRS network;
receipt of data information for a given accepted client from the GPRS network by the GPRS card; and
transmitting the data information from the server to the client.

4. The method as claimed in claim 1 further comprising the step of:
for each of accepted clients, determining whether the client requires the wireless communication.

5. The method as claimed in claim 1, wherein the registration information comprises an IP address of the client.

6. A system for sharing a single general packet radio service (GPRS) card over a LAN, comprising:
one or more clients; and
a server coupled to the clients through the LAN, for receiving registration information from the clients, checking whether each of the clients has usage authorization, and transmitting successful registration information thereto, the server comprising a GPRS card for accepted clients to communicate wirelessly.

7. The system as claimed in claim 6, wherein each of the clients comprises:
a determining unit for determining whether the client requires wireless communication;
a network card for connecting the client to the LAN; and
a transceiver for receiving data information from the server and transmitting data information from the client to the server.

8. The system as claimed in claim 6, wherein the server further comprises:
a network card for connecting the server to the LAN.

9. The system as claimed in claim 6, wherein the GPRS card receives data information for a given accepted client from a GPRS network and transmits the data information from the server to the client, and the GPRS card also receives data information from accepted clients and transmits the data information from the server to the GPRS network.

10. The system as claimed in claim 9, wherein the GPRS card comprises:
a USB port for connecting the GPRS card and the server;
a processor coupled to the USB port;
an encoder/decoder (CODEC) coupled to the processor;
a wireless communication module coupled to the CODEC; and
an antenna for receiving data information from the GPRS network and transmitting data information received from the clients to the GPRS network;
wherein, according the data information received from the GPRS network, the processor determines which client will receive the data information, the CODEC encodes the data information transmitted from the processor and decodes the data information transmitted from the wireless communication module, and the wireless communication module transmits the data information encoded by the CODEC.
